(19) United States
(12) Patent Application Publication
(10) Pub. No.: US 2018/0099458 A1
(43) Pub. Date: Apr. 12, 2018

(54) ADDITIVE MANUFACTURING POWDER LOADING

(71) Applicant: General Electric Company, Schenectady, NY (US)

(72) Inventors: Donnell Eugene Crear, Simpsonville, SC (US); Archie Lee Swanner, JR., Easley, SC (US)

(21) Appl. No.: 15/286,773

(22) Filed: Oct. 6, 2016

(51) Int. Cl. B29C 67/00; B33Y 30/00

(52) U.S. Cl. CPC B29C 67/0088; B29K 2105/251; B33Y 30/00

(57) ABSTRACT

A powder-filling apparatus includes a rolling frame, a powder hopper, and a powder-transferring apparatus. The rolling frame includes a support base and a lifting element coupled to the support base, the lifting element having a portion linearly movable toward and away from the support base. The powder hopper is mounted on the lifting element and adjustable in height with adjustment of the lifting element to achieve filling positions over a plurality of differently sized additive manufacturing printers. The powder-transferring apparatus is coupled with the powder hopper and is configured to transfer additive manufacturing powder from an additive manufacturing powder container to the powder hopper.

### BACKGROUND OF THE INVENTION

The subject matter disclosed herein relates to additive manufacturing. More particularly, the subject matter disclosed herein relates to apparatuses and systems for loading powder in an additive manufacturing printer.

Additive manufacturing (AM) may include any process of producing an object through the successive layering of material rather than the removal of material, which is the case with conventional processes. Additive manufacturing can create complex geometries without the use of any sort of tools, molds or fixtures, and with little or no waste material. Instead of machining components from solid billets of plastic, much of which is cut away and discarded, the only material used in additive manufacturing is what is required to shape the part. Additive manufacturing processes may include but are not limited to 3D printing, rapid prototyping (RP), direct digital manufacturing (DDM), selective laser melting (SLM), and direct metal laser melting (DMLM).

In many additive manufacturing systems that use an AM powder, the powder is loaded into a feed hopper (often gravity fed or gravity assisted), from where the powder is fed into an AM printer. These gravity fed hoppers are located above the AM printer. The AM printer is large or tall relative to an average human, such that loading powder into the feed hopper generally involves carrying a container of powder up a ladder and pouring the powder from atop the ladder into the feed hopper. The powder containers can be very heavy and cumbersome for an average human, so carrying the powder containers up the ladder to pour the powder into the feed hopper can be quite difficult. Further, pouring the heavy powder manually, especially balancing one's self from atop a ladder, can result in spilled powder and the release of a significant amount of dust. Powder dust can facilitate clogs in jet nozzles that dispense binder material used to bind the powder during printing. Furthermore, multiple AM printers are often located within a work area, each AM printer requiring a powder container to be lifted above the respective AM printer.

### BRIEF DESCRIPTION OF THE INVENTION

In one embodiment, a powder-filling apparatus for an additive manufacturing printer includes a rolling frame, a powder hopper, a powder-transferring apparatus, and a control system. The rolling frame includes a support base, a first longitudinal lifting member coupled with the support base and extending away from the support base, and a second longitudinal lifting member coupled to the first longitudinal lifting member. The powder hopper is configured to hold additive manufacturing powder and is coupled with the second longitudinal lifting member. The powder-transferring apparatus is coupled with the powder hopper, and is configured to transfer additive manufacturing powder from an additive manufacturing powder container to the powder hopper. The control system is configured to actuate the powder-transferring apparatus.

In another embodiment, a powder-filling apparatus includes a rolling frame, a powder hopper, and a powder-transferring apparatus. The rolling frame includes a support base and a lifting element coupled to the support base, the lifting element having a portion linearly movable toward and away from the support base. The powder hopper is mounted on the lifting element and adjustable in height with adjustment of the lifting element to achieve filling positions over a plurality of differently sized additive manufacturing printers. The powder-transferring apparatus is coupled with the powder hopper and is configured to transfer additive manufacturing powder from an additive manufacturing powder container to the powder hopper.

In another embodiment, a system includes at least one computing device configured to detect a first fill level of an additive manufacturing powder in a feed reservoir of an additive manufacturing printer is less than a first threshold level, open an outflow valve in a powder hopper to release additive manufacturing powder into the feed reservoir in response to detecting the first fill level in the feed reservoir is less than the first threshold level, detect a second fill level of the additive manufacturing powder in the powder hopper is less than a second threshold level, and actuate a powder transfer apparatus coupled with the powder hopper to transfer additive manufacturing powder into the powder hopper from an additive manufacturing powder container in response to detecting the second fill level in the powder hopper is less than the second threshold level.

### BRIEF DESCRIPTION OF THE DRAWINGS

These and other features of this invention will be more readily understood from the following detailed description of the various aspects of the invention taken in conjunction with the accompanying drawings that depict various embodiments of the disclosure, in which:

FIG. 1 shows a schematic/block view of an illustrative computerized additive manufacturing system for generating an object.

FIG. 2 shows a perspective view of a powder-filling apparatus for an additive manufacturing printer, according to various embodiments.

FIG. 3 shows a perspective view of a powder-filling apparatus for an additive manufacturing printer, according to various embodiments.

FIG. 4 shows a schematic/block view of a computerized powder-filling apparatus, according to various embodiments of the invention.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant components of an additive manufacturing printer. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. It is often required to describe parts that are at differing radial positions with regard to a center axis. It will be appreciated that such terms may be applied in relation to the center axis of the turbine. In various embodiments, components described as being “coupled” to one another can be joined along one or more interfaces. In some embodiments, these interfaces can include junctions between distinct components, and in other cases, these interfaces can include a solidly and/or integrally formed interconnection. That is, in some cases, components that are “coupled” to one another can be simultaneously formed to define a single continuous member. However, in other embodiments, these coupled components can be formed as separate members and be subsequently joined through known processes (e.g., fastening, ultrasonic welding, bonding).

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

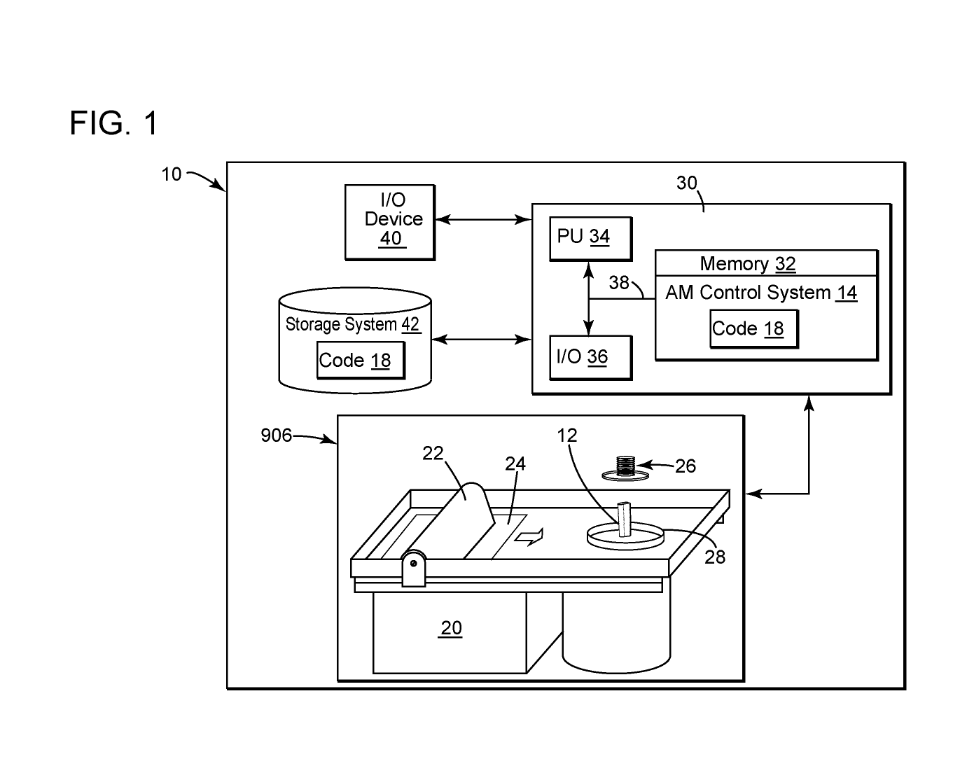

As indicated above, the subject matter disclosed herein relates to AM printers and systems, and more particularly to mobile apparatuses and systems for filling AM powder into AM printers. To illustrate an example of an additive manufacturing process, FIG. 1 shows a schematic/block view of an illustrative computerized additive manufacturing system 10 for generating an object 12. In this example, system 10 is arranged for DMLM. It is understood that the general teachings of the disclosure are equally applicable to other forms of additive manufacturing. Object 12 is illustrated as a double walled turbine element; however, it is understood that the additive manufacturing process can be readily adapted to manufacture other parts as desired. AM system 10 generally includes a computerized additive manufacturing (AM) control system 14 and an AM printer 16. AM system 10, as will be described, executes code 18 that includes a set of computer-executable instructions defining object 12 to physically generate object 12 using AM printer 16. Each AM process may use different raw materials in the form of, for example, fine-grain powder, liquid (e.g., polymers), sheet, etc., a stock of which may be held in a chamber 20 of AM printer 16. As illustrated, an applicator 22 may create a thin layer of raw material 24 spread out as the blank canvas from which each successive slice of the final object will be created. In the example shown, a laser or electron beam 26 fuses particles for each slice, as defined by code 18. Various parts of AM printer 16 may move to accommodate the addition of each new layer, e.g., a build platform 28 may lower and/or chamber 20 and/or applicator 22 may rise after each layer.

AM control system 14 is shown implemented on computer 30 as computer program code. To this extent, computer 30 is shown including a memory 32, a processor 34, an input/output (I/O) interface 36, and a bus 38. Further, computer 30 is shown in communication with an external I/O device/resource 40 and a storage system 42. In general, processor 34 executes computer program code, such as AM control system 14, that is stored in memory 32 and/or storage system 42 under instructions from code 20 representative of object 12. While executing computer program code, processor 34 can read and/or write data to/from memory 32, storage system 42, I/O device 40 and/or AM printer 16. Bus 38 provides a communication link between each of the components in computer 30, and I/O device 40 can comprise any device that enables a user to interact with computer 40 (e.g., keyboard, pointing device, display, etc.). Computer 30 is only representative of various possible combinations of hardware and software. For example, processor 34 may comprise a single processing unit, or be distributed across one or more processing units in one or more locations, e.g., on a client and server. Similarly, memory 32 and/or storage system 42 may reside at one or more physical locations. Memory 32 and/or storage system 42 can comprise any combination of various types of non-transitory computer readable storage medium including magnetic media, optical media, random access memory (RAM), read only memory (ROM), etc. Computer 30 can comprise any type of computing device such as a network server, a desktop computer, a laptop, a handheld device, a mobile phone, a pager, a personal data assistant, etc.

Additive manufacturing processes begin with a non-transitory computer readable storage medium (e.g., memory 32, storage system 42, etc.) storing code 18 representative of object 12. As noted, code 18 includes a set of computer-executable instructions defining object 12 that can be used to physically generate object 12, upon execution of code 18 by system 10. For example, code 18 may include a precisely defined 3D model of object 12 and can be generated from any of a large variety of well known computer aided design (CAD) software systems such as AutoCAD®, TurboCAD®, DesignCAD 3D Max, etc. In this regard, code 18 can take any now known or later developed file format. For example, code 18 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 18 may be translated between different formats, converted into a set of data signals and transmitted, received as a set of data signals and converted to code, stored, etc., as necessary. Code 18 may be an input to system 10 and may come from a part designer, an intellectual property (IP) provider, a design company, the user or owner of system 10, or from other sources. In any event, AM control system 14 executes code 18, dividing object 12 into a series of thin slices that it assembles using AM printer 16 in successive layers of liquid, powder, sheet or other material. In the DMLM example, each layer is melted to the exact geometry defined by code 18 and fused to the preceding layer. Subsequently, object 12 may be exposed to any variety of finishing processes, e.g., minor machining, sealing, polishing, assembly to another part, etc.

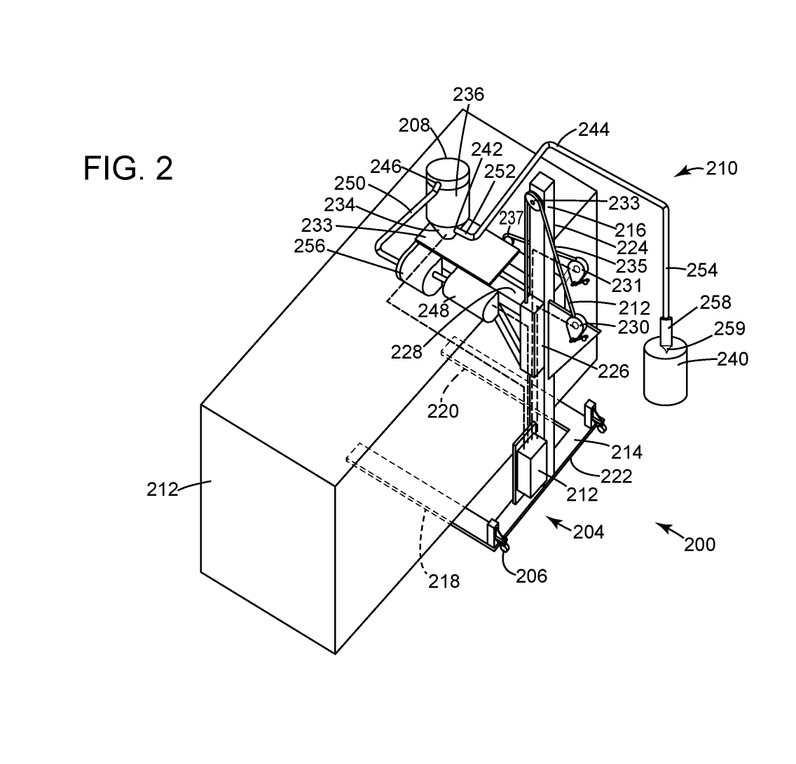

FIG. 2 shows a perspective view of a powder-filling apparatus 200 for an AM printer 202. Powder-filling apparatus 200 can be mobile, to be moved between AM printer 202 and/or other AM printers. Powder-filling apparatus 200 includes a rolling frame 204, a powder hopper 208, a powder-transferring apparatus 210, and a control system 212. Rolling frame 204 includes a support base 214 and a lifting element 216 coupled to support base 214. Support base 214 provides stability for the other parts of rolling frame 204 and other components mounted or attached to rolling frame 204, as will be described below. Support base 214 can be configured in many ways to provide appropriate stability and support. In FIG. 2, support base 214 is shown having a first longitudinal base member 218, a second longitudinal base member 220, and a cross base member 222 coupled with first longitudinal base member 218 and second longitudinal base member 220, cross base member 222 extending from first longitudinal base member 218 to second longitudinal base member 220. Cross base member 222 connects to each longitudinal base member 218, 220, to brace and stabilize longitudinal base members 218, 220 with respect to each other, and provide a center location between longitudinal base members 218, 220 to mount lifting element 216. First longitudinal base member 218, second longitudinal base member 220, extend over a relatively wide area to reduce a chance of rolling frame 204 toppling. Base members 218, 220, 222 are configured similar to a two-pronged fork, with base members 218, 220 being analogous to each prong. Base members 218, 220, 222 can have a height low enough to fit in any gap between AM printer 202 and a floor surface upon which AM printer 202 is situated. First and second longitudinal base members 218, 220 can extend under AM printer 202 between any supports or support legs supporting AM printer 202. While a particular configuration of rolling frame 204 has been illustrated, it is emphasized that rolling frame 204 can take a variety of different forms within the teachings of the disclosure.

Rolling frame 204 may include a number of rollers 206 mounted on or coupled to rolling frame 204 to facilitate rolling frame 204 from, for example, one AM printer to another AM printer or within a work area. Rollers 206 are located to support rolling frame 204 on a surface when rolling frame 204 is oriented in an upright position. Rolling frame 204 can be equipped with any number of rollers 206 as appropriate to enable rolling frame 204 to be supported stably on a surface. The desired number of rollers can vary with the configuration of rolling frame 204, and in particular support base 214. FIG. 2 shows four rollers 206. Rollers 206 can be wheels, bearings, or another now known or later developed device or element enabling rolling frame 204 to roll on a surface. Rolling frame 204 being mobile in this manner enables an operator to conveniently move power-filling apparatus 200 between multiple AM printers and fill the multiple AM printers.

Lifting element 216 enables height adjustment of powder hopper 208 to position powder hopper 208 in powder feeding position over variously sized AM printers. Lifting element 216 can be configured variously to lift powder hopper 208, which is mounted on lifting element 216, away from support base 214 or to lower powder hopper 208 toward support base 214, depending on, for example, the height of the AM printer needing powder. In FIG. 2, lifting element 216 is shown having a first longitudinal lifting member 224, which is coupled to support base 214, in particular cross base member 222, and which extends from support base 214 away from support base 214 to a second longitudinal lifting member 226. Second longitudinal lifting member 226 is coupled to first longitudinal lifting member 224, with an arm portion 228 extending away from first longitudinal lifting member 224. Second longitudinal lifting member 226 is spaced from support base 214 a distance along first longitudinal lifting member 224.

A height adjustment actuator 230 can be coupled with first longitudinal lifting member 224, and can be configured to adjust the distance by moving the second longitudinal lifting member 226 relative to the support base 214. Second longitudinal lifting member 226 is linearly movable toward and away from support base 214. First longitudinal lifting member 224 and second longitudinal lifting member 226 can be configured variously with respect to each other, depending in part on how height adjustment actuator 230 operates to facilitate moving second longitudinal lifting member 226. Any now known or later developed actuator can be used, such as, but not limited to, a hydraulic actuator, a pneumatic actuator, a worm gear, etc. In FIG. 2, for example, height adjustment actuator 230 is shown as a height adjustment crank 230, with height adjustment cables 232 and one or more height adjustment pulleys 233, that operate to crank second longitudinal lifting member 226 up or down in sliding engagement with first longitudinal lifting member 224. A human user can manually crank height adjustment crank 230 to lift or lower second longitudinal lifting member 226 to adjust the height of powder hopper 208 to achieve a plurality of different height filling positions for a plurality of differently sized additive manufacturing printers. Height adjustment actuator 230 (e.g., height adjustment crank 230) can be automated, non-manually powered (e.g., electrically powered), and coupled to control system 212 to be controlled by control system 212.

When positioned at AM printer 202, arm portion 228 reaches over AM printer 202 to position powder hopper 208, which can be mounted on the arm portion 228, to feed AM powder into AM printer 202. Powder hopper 208 can be positioned over AM printer 202 by moving the entire rolling frame 204, or by adjusting a horizontal adjustment actuator 231, which can be configured to adjust the distance of powder hopper 208 from first longitudinal lifting member 224 in a direction of a longitude of arm portion 228. Any now known or later developed actuator can be used, such as, but not limited to, a hydraulic actuator, a pneumatic actuator, a worm gear, etc. Horizontal adjustment actuator 231 can be mounted on arm portion 228 or first longitudinal lifting member 224, and can engage a horizontal adjustment member 233 movably (e.g., slidably) mounted on arm portion 228. Powder hopper 208 can be mounted on arm portion 228 by way of horizontal adjustment member 228, and powder hopper 208 and horizontal adjustment member 233 can be pushed and pulled with actuation of the horizontal adjustment actuator 231.

In FIG. 2, for example, horizontal adjustment actuator 231 is shown as a horizontal adjustment crank 231 mounted to arm portion 224, with horizontal adjustment cables 235 and one or more horizontal adjustment pulleys 237, which operate to crank horizontal adjustment member 233 along arm portion 224 in sliding engagement with arm portion 224. A human user can manually crank horizontal adjustment crank 231 to adjust horizontal adjustment member 237 and the position of powder hopper 208 over AM printer 202. Horizontal adjustment member 237 (e.g., horizontal adjustment crank 230) can be automated, non-manually powered (e.g., electrically powered), and coupled to control system 212 to be controlled by control system 212. Powder hopper 208 includes a container 230 for AM powder, with a drain opening 232 for moving powder out of powder hopper 208 into AM printer 202. A funnel 234 can taper from a body 236 of powder hopper 208 to drain opening 232. An outflow valve 238 can be located in the opening of drain opening 232 to close and open drain opening 232 to retain powder in powder hopper 208 or release powder from powder hopper 208. As discussed above, powder hopper 208 is coupled with arm portion 228 of second longitudinal lifting member 226 and thusly can be extended out over AM printer 202 to load AM printer 202 with AM powder. Powder hopper 208 is oriented with drain opening 232 generally facing downward so gravity can draw powder out of hopper 208.

Powder hopper 208 also has a fill opening 242 located proximate drain opening 232, which can be at a junction of body 236 and funnel 234, and proximate or adjacent a bottom of powder hopper 208 when powder hopper 208 is oriented in an upright position. A transfer conduit 244, described further below, may be coupled to fill opening 242 to transfer AM powder into powder hopper 208 through fill opening 242.

In various embodiments, powder hopper 208 can also have a vacuum suction opening 246 located proximate or adjacent a top of powder hopper 208 when powder hopper 208 is oriented in an upright position. In other words, vacuum suction opening 246 can be at an end of body 236 opposite funnel 234. A vacuum generator 248, discussed further below, can be coupled to vacuum suction opening 246 via a suction hose 250 to pull air out of the top of powder hopper 208, which pulls air into the bottom of powder hopper 208 from transfer conduit 244.

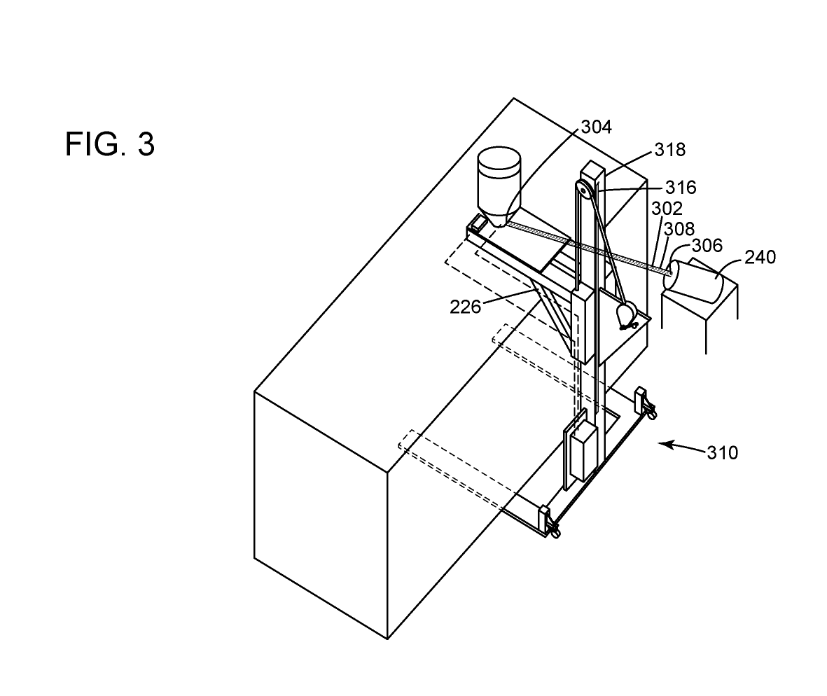

Powder-transferring apparatus 210 is coupled with powder hopper 208, and is configured to transfer AM powder from an AM powder container 240 to powder hopper 208. AM powder container 240 can be positioned anywhere desired by a human user to conveniently load AM printer 202 and avoid lifting or carrying AM powder container 240 to a loading point above and over AM printer 202. Various motive methods can be implemented to transfer powder including vacuum suction and screw auger conveying. FIG. 2 shows a powder-transferring apparatus 210 using a vacuum. FIG. 3 shows a powder-transferring apparatus 310 using an auger 302 to convey powder. These implementations provide examples, and other now known or later developed ways to move powder from one location to another can be substituted for the illustrative vacuum apparatus and screw auger apparatus.

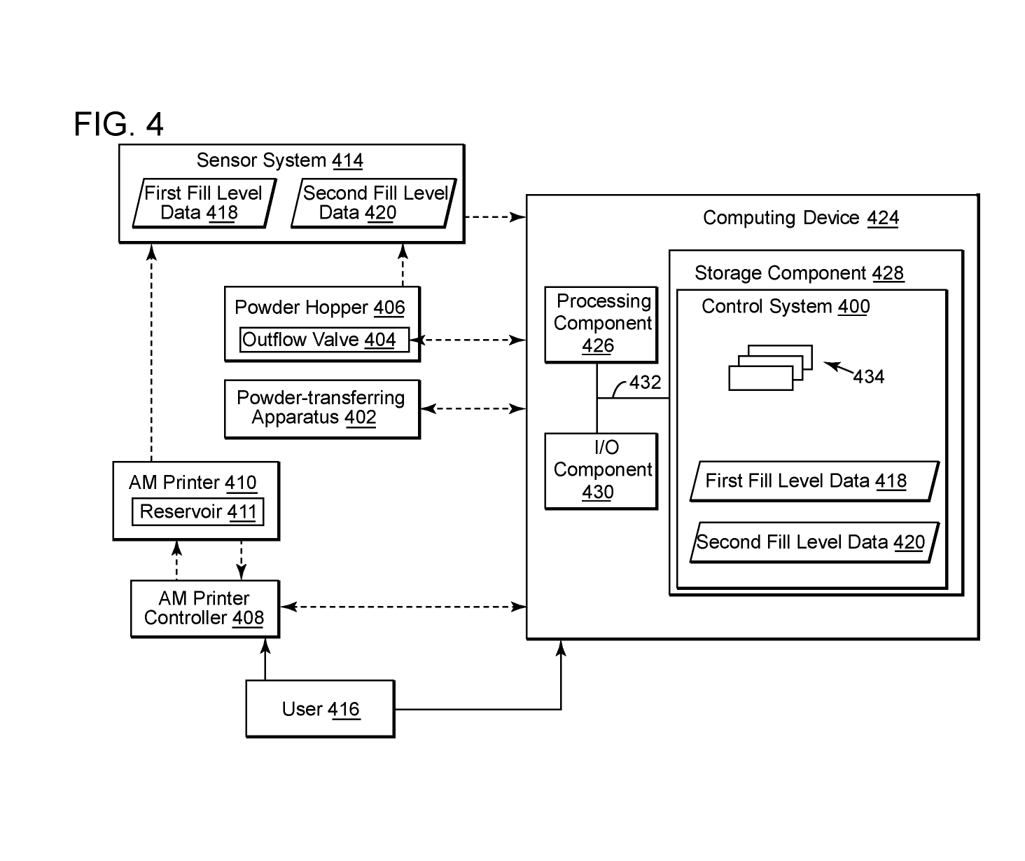

In FIG. 2, powder-transferring apparatus 210 includes vacuum generator 248, suction hose 250, and transfer conduit 244. Transfer conduit 244 can be a hose, tube, or other enclosed pathway with a first end 252 coupled to fill opening 242 of powder hopper 208. Vacuum generator 248, which can be mounted on arm portion 228 or another portion of rolling frame 204, is coupled to vacuum suction opening 246 of powder hopper 208 through suction hose 250, such that vacuum generator 248 generates a vacuum to draw gas from powder hopper 208 through suction hose 250, and when outflow valve 238 is closed, from a second, free end 254 of transfer conduit 244 to powder hopper 208. Vacuum generator 248 can be coupled to control system 212, such that vacuum generator 248 can be powered on and off, and generally controlled by control system 212. Control system 212 can include a simple on/off switch that can be manually activated to actuate powder-transferring apparatus by powering on or off vacuum generator 248. Control system 212 can also be more complex, as described with reference to FIG. 4 below.

In some embodiments, an air filter 256, which can also be mounted on arm portion 228 or another portion of rolling frame 204, can be in line between, and in fluid communication with, vacuum generator 248 and powder hopper 208 to filter powder particles and dust. Because fill opening 242 is located toward or at the bottom of powder hopper 208, and vacuum suction opening 246 is located toward or at the top of powder hopper 208, as powder enters powder hopper 208, the weight of most powder particles causes the powder to stay near the bottom, and due to convection within powder hopper 208, to circulate within powder hopper 208 below vacuum suction opening 246. Some finer dust particles of powder can be vacuumed through vacuum suction opening 246, and filter 256 can be beneficial to remove those particles and avoid emitting the particles into the air or clogging vacuum generator 248 with the particles. To facilitate suctioning AM powder into transfer conduit 244, a transfer conduit end attachment 258 can be coupled to second, free end 254 of transfer conduit 244. Transfer conduit end attachment 258 can have a nozzle 259 shaped or configured to increase suction. A multitude of shapes and configurations can facilitate suction of powder through transfer conduit end attachment 258. For example, transfer conduit end attachment 258 can taper to the nozzle 259, such that a relatively narrow opening at nozzle 259 provides more suction force per area. Nozzle 259 can be round, elliptical, an elongated ellipse or slit, or a variety of other shapes. Transfer conduit end attachment 258 can also be relatively rigid to facilitate insertion of the transfer conduit end attachment 258 into powder.

FIG. 3 illustrates powder-transferring apparatus 310, including auger 302 having a first end 304 and a second end 306. Components illustrated in FIG. 3 are generally the same as like components illustrated in FIG. 2, except where noted otherwise. Auger 302 is enclosed in a transfer conduit 308. Transfer conduit 308 is coupled to powder hopper 309 at first end 304 of auger 302. An auger actuator 312 can power and rotate auger 302. Auger 302 is coupled to control system 314 through auger actuator 312, which can be turned on, turned off, and generally controlled by control system 314. Control system 314 can include a simple on/off switch that can be manually activated to power auger 302 on and off, or control system 314 be more complex, as described with reference to FIG. 4 below. Second end 306 of auger 302 can be positioned in a location convenient for a human user to insert second end 306 into powder container 240. Auger 302 actuates by rotating or screwing to pull powder from powder container 240, through transfer conduit 308, and deliver the powder to powder hopper 309. As discussed above, other now known or later developed conveying apparatuses can be used to convey or transfer AM powder from powder container 240. Powder hopper 309 may generally be the same as powder hopper 208, except vacuum suction opening 246 may be unnecessary in powder hopper 309. Actuator 230 is shown as a crank, but varying from FIG. 2, cables and pulleys are hidden inside a slot 316 which runs a longitudinal length of first longitudinal lifting member 318. As with FIG. 2, crank 230 operates to move second longitudinal lifting member 226 up or down in sliding engagement with first longitudinal lifting member 316.

In each embodiment, as shown in FIG. 2 and FIG. 3, an electrical grounding wire 260, 360 is coupled with transfer conduit 244, 308 to discharge static electrical charge that can build as a result of the powder moving through transfer conduit 244. In each embodiment of FIG. 2 and FIG. 3, control system 212, 314 (respectively) can be mounted to rolling frame 204 and can be coupled with outflow valve 238 and/or powder-transferring apparatuses 210, 310 (e.g. by way of vacuum generator or auger actuator 312) to control operation of outflow valve 238 and/or powder-transferring apparatuses 210, 310. Control systems 212, 314 are described further below with reference to FIG. 4.

FIG. 4 illustrates a control system 400 coupled with and in communication with powder-transferring apparatus 402, an outflow valve 403 of powder hopper 404, a height adjustment actuator 405, and a horizontal adjustment actuator 406, to control powder-transferring apparatus 402, outflow valve 403, height adjustment actuator 405, and horizontal adjustment actuator 406. Powder-transferring apparatus 402, outflow valve 403, height adjustment actuator 405, and horizontal adjustment actuator 406, as well as other powder-filling apparatus components discussed with respect to FIG. 4, can be as described with respect to either FIG. 2 or FIG. 3. Control system 400 can also be also coupled with, and in communication with, an AM printer controller 408, which controls an AM printer 410, and with a sensor system 414. AM printer controller 408 and AM printer 410 can be identical to, similar to, or a variation of AM control system 14 and AM printer 16 of FIG. 1. A human user 416 can provide input to printer controller 408 and control system 400. Control system 400 and its function, as described below, can be implemented with respect to powder-filling apparatus 200 of FIG. 2, and it should be noted that control system 400 would similarly be employed with powder-transferring apparatus 310 of FIG. 3, as well as other variations of the powder-transferring apparatus. It should also be noted that while control system 400 is described with various functions, these functions are not all required. Control system 400 could be as simple as a function to turn on and off powder-transferring apparatus 402, and/or open and close outflow valve 403.

As described herein, control system 400 can be configured, e.g., programmed, to perform particular functions. In various embodiments, control system 400 is configured to:

A) open an outflow valve in a powder hopper to release AM powder into a feed reservoir of an AM printer;

B) determine a second fill level of the additive manufacturing powder in the powder hopper is less than a second threshold level; and

C) actuate a powder-transfer apparatus coupled with the powder hopper to transfer AM powder into the powder hopper from an AM powder container in response to detecting the second fill level in the powder hopper is less than the second threshold level.

In various embodiments automating positioning of powder hopper 404, control system 400 can also be configured to:

D) actuate a height adjustment actuator in response to input from a user; and

E) actuate a horizontal adjustment actuator in response to input from a user.

In some cases, user 416 can position hopper 406 over AM printer 410 by interfacing with computing device 424 and/or control system 400. For example, user 416 might input information regarding AM printer 410, such as, but not limited to, make and model. In this case, storage component 428 may have stored a database of AM printers containing information regarding the height to which powder hopper 404 should be raised. Accessing this database, control system 400 can actuate height adjustment actuator 405 to raise powder hopper 404 to the appropriate height in response to user inputting relevant information designating the AM printer. User 416 can also input information (e.g., press a button or key) equating to raise, lower, move out (e.g., away from first longitudinal lifting member), or move in (e.g., toward first longitudinal lifting member), to actuate height adjustment actuator 405 or horizontal adjustment actuator 406 in the desired direction until user 416 determines powder hopper 404 is positioned appropriately.

In some cases, control system 400 opens outflow valve 403 according to a preprogrammed timing that can be set by human user 414 based on knowledge regarding how long it takes for AM printer 410 to use up AM powder. Likewise, control system 400 can close valve 403 according to a preprogrammed timing based on knowledge regarding how long it takes to fill feed reservoir 411 of AM printer 410 with AM powder.

In other cases, control system 400 determines that a first fill level of an AM powder in feed reservoir 411 of an AM printer 410 is less than a first threshold level, and then opens outflow valve 403 in powder hopper 404 to release AM powder into feed reservoir 411 in response to determining that the first fill level in feed reservoir 411 is less than the first threshold level. In this latter case, sensor system 414 can detect fill conditions (first fill level data 418) of AM printer 410, and control system 400 can receive a signal from sensor system 414 identifying first fill level data 418, or read first fill level data 418, to determine that the first fill level of AM powder in AM printer 410 is less than the first threshold level. This first fill level data 418 may be obtained by control system 400 from one or more sensors (sensor system) 414 coupled to AM printer 410, and/or AM printer controller 408, etc., and control system 400 may read first fill level data 418 from any of these locations (sensor system 414, AM printer controller 408, etc.). The sensors can be conventionally used and/or integrated with AM printer 410, or they can be added as necessary. A proximity sensor configured to detect the presence of AM powder at a particular level in a powder supply container or hopper inside the AM printer 410 is a conventional sensor, but sensors can also include flow meters, motion sensors, or another suitable sensor.

In some embodiments, in response to determining that a first fill level of an AM powder in feed reservoir 411 of an AM printer 410 is less than a first threshold level, control system 400 opens outflow valve 403 in powder hopper 404 to release AM powder into AM printer 410. Control system 400 can similarly detect that AM printer 410 is full or nearing being full, and in response, control system 400 can close outflow valve 403.

In some cases, control system 400 actuates powder-transferring apparatus 404 (e.g., by powering vacuum generator 248 or auger 302), which can be done according to a preprogrammed timing that can be set by human user 414 based on knowledge and experience regarding how long it takes to fill AM printer 410 and powder hopper 404. Likewise, control system 400 can turn off powder-transferring apparatus 404 according to a preprogrammed timing based on knowledge and experience regarding how long it takes to fill AM printer 410 and powder hopper 404.

In other cases, control system 400 determines whether a second fill level of AM powder in powder hopper 404 is less than a second threshold level, and actuates powder-transfer apparatus 402 to transfer AM powder into powder hopper 404 from an AM powder container (see 240 in FIG. 2) in response to determining that the second fill level in powder hopper 404 is less than the second threshold level. In this latter case, sensor system 414 can detect fill conditions (including second fill level data 420) of AM printer 410, and control system 400 can receive a signal from sensor system 414 identifying the second fill level 420, or can read second fill level data 420 to determine that the second fill level of AM powder in powder hopper 404 is less than the second threshold level. This second fill level data 420 may be obtained by control system 400 from one or more sensors (sensor system) 414 coupled to powder hopper 404, and control system 400 may receive or read second fill level data 420 from sensor system 414. Sensors can include a plurality of conventional sensors such as conventional fill level sensors (e.g., proximity sensors) used to detect the level of AM powder in the AM powder supply container, or other conventional sensors such as flow meters, motion sensors, etc. Control system 400 can similarly determine that powder hopper 404 is full or nearing being full, and in response, control system 400 can turn off powder-transferring apparatus 402 to stop filling powder hopper 404 with AM powder.

As described herein, control system 400 can include any conventional control system components used in controlling a powered system. For example, control system 400 can include electrical and/or electro-mechanical components for actuating one or more components in valve 403 or powder-transferring apparatus 402. Control system 400 can include conventional computerized sub-components such as a processor, memory, input/output, bus, etc. Control system 400 can be configured (e.g., programmed) to perform functions based upon operating conditions from an external source (e.g., at least one computing device 424), and/or may include pre-programmed (encoded) instructions based upon parameters of AM printer 410 and/or powder hopper 404.

In various embodiments, control system 400 is embodied, e.g., stored and/or operated in at least one computing device 424, which is connected with powder-transferring apparatus 402 and outflow valve 403. In various embodiments, computing device 424 is operably connected with powder-transferring apparatus 402, valve 403, and/or AM printer 410, e.g., via sensor system 414.

Computing device 424 is shown in communication with sensor system 414, which may store fill level data 418, 420. Further, computing device 424 is shown in communication with user 416. User 416 may be, for example, a programmer or user. Interactions between these components and computing device 424 are discussed elsewhere in this application.

One or more of the processes described herein can be performed, e.g., by at least one computing device, such as computing device 424, as described herein. In other cases, one or more of these processes can be performed according to a computer-implemented method. In still other embodiments, one or more of these processes can be performed by executing computer program code (e.g., control system 400) on at least one computing device (e.g., computing device 424), causing the at least one computing device to perform a process, e.g., filling an AM printer with AM powder.

In further detail, computing device 424 is shown including a processing component 426 (e.g., one or more processors), a storage component 428 (e.g., a storage hierarchy), an input/output (I/O) component 430 (e.g., one or more I/O interfaces and/or devices), and a communications pathway 432. In one embodiment, processing component 426 executes program code, such as control system 400 (e.g., in particular embodiments when embodied as program code), which is, in these particular cases, at least partially embodied in storage component 428. While executing program code, processing component 426 can process data, which can result in reading and/or writing the data to/from storage component 428 and/or I/O component 430 for further processing. Pathway 432 provides a communications link between each of the components in computing device 424. I/O component 430 can comprise one or more human I/O devices or storage devices, which enable user 416, powder-transferring apparatus 402, valve 403, and/or control system 400 to interact with computing device 424 and/or one or more communications devices to enable user 416, powder-transferring apparatus 402, valve 403, and/or control system 400 to communicate with computing device 424 using any type of communications link. To this extent, control system 400 manages a set of interfaces (e.g., graphical user interface(s), application program interface, and/or the like) that enable human and/or system interaction with control system 400.

In any event, computing device 424 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, control system 400 can be embodied as any combination of system software and/or application software. In any event, the technical effect of computing device 424 is to control filling of AM printer 410 with AM powder.

Further, control system 400 can be implemented using a set of modules 434. In this case, a module 434 can enable computing device 424 to perform a set of tasks used by control system 400, and can be separately developed and/or implemented apart from other portions of control system 400. Control system 400 may include modules 434 which comprise a specific use machine/hardware and/or software. Regardless, it is understood that two or more modules, and/or systems may share some/all of their respective hardware and/or software. Further, it is understood that some of the functionality discussed herein may not be implemented or additional functionality may be included as part of computing device 424.

When computing device 424 comprises multiple computing devices, each computing device may have only a portion of control system 400 embodied thereon (e.g., one or more modules 434). However, it is understood that computing device 424 and control system 400 are only representative of various possible equivalent computer systems that may perform a process described herein. To this extent, in other embodiments, the functionality provided by computing device 424 and control system 400 can be at least partially implemented by one or more computing devices that include any combination of general and/or specific purpose hardware with or without program code. In each embodiment, the hardware and program code, if included, can be created using standard engineering and programming techniques, respectively.

Regardless, when computing device 424 includes multiple computing devices, the computing devices can communicate over any type of communications link. Further, while performing a process described herein, computing device 424 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, control system 400 enables computing device 424 to control filling AM printer 410 with AM powder. Control system 400 may include logic for performing one or more actions described herein. In one embodiment, control system 400 may include logic to perform the above-stated functions. Structurally, the logic may take any of a variety of forms such as a field programmable gate array (FPGA), a microprocessor, a digital signal processor, an application specific integrated circuit (ASIC) or any other specific use machine structure capable of carrying out the functions described herein. Logic may take any of a variety of forms, such as software and/or hardware. However, for illustrative purposes, control system 400 and logic included therein will be described herein as a specific use machine. As will be understood from the description, while logic is illustrated as including each of the above-stated functions, not all of the functions are necessary according to the teachings of the invention as recited in the appended claims.

In any case, the technical effect of the various embodiments of the invention, including, e.g., the control system 400, is to control filling of AM printer 410 with powder.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A powder-filling apparatus for an additive manufacturing printer, the apparatus comprising:
a rolling frame including a support base, a first longitudinal lifting member coupled with the support base and extending away from the support base, and a second longitudinal lifting member coupled to the first longitudinal lifting member;
a powder hopper configured to hold additive manufacturing powder and coupled with the second longitudinal lifting member;
a powder-transferring apparatus coupled with the powder hopper, the powder-transferring apparatus configured to transfer additive manufacturing powder from an additive manufacturing powder container to the powder hopper; and
a control system configured to actuate the powder-transferring apparatus.

2. The powder-filling apparatus of claim 1, wherein the support base has a first longitudinal base member, a second longitudinal base member, and a cross base member coupled to the first longitudinal base member and the second longitudinal base member, and extending from the first longitudinal base member to the second longitudinal base member.

3. The powder-filling apparatus of claim 1, wherein the second longitudinal lifting member is spaced from the support base a distance along the first longitudinal lifting member, and wherein the powder-filling apparatus further comprises a height adjustment actuator coupled with the first longitudinal lifting member, the height adjustment actuator configured to adjust the distance by moving the second longitudinal lifting member relative to the support base.

4. The powder-filling apparatus of claim 1, wherein the powder hopper has a drain opening and an outflow valve located in the drain opening to close and open drain opening to retain powder in or release powder from the powder hopper, and wherein the control system controls opening and closing of the outflow valve.

5. The powder-filling apparatus of claim 1, wherein the powder-transferring apparatus comprises a vacuum generator in fluid communication with the hopper.

6. The powder-filling apparatus of claim 5, wherein the powder-transferring apparatus comprises a transfer conduit having a first end, the first end of the transfer conduit coupled to the powder hopper.

7. The powder-filling apparatus of claim 6, wherein the transfer conduit comprises a second end, and wherein the powder-transferring apparatus comprises a transfer conduit end attachment coupled to the second end of the transfer conduit to facilitate suctioning powder into the transfer conduit.

8. The powder-filling apparatus of claim 1, wherein the powder-transferring apparatus comprises an auger positioned to deliver powder from a powder container to the powder hopper.

9. The powder-filling apparatus of claim 1, further comprising an electrical grounding wire coupled with the powder-transferring apparatus to reduce static charge buildup.

10. The powder-filling apparatus of claim 1, wherein the control system determines whether the amount of powder in the powder hopper is below a threshold level, and actuates the powder-transferring apparatus as a result of determining that the amount of powder is below the threshold level.

11. An additive manufacturing printer including a powder-filling apparatus, the powder-filling apparatus comprising:
a rolling frame including a support base and a lifting element coupled to the support base, the lifting element having a portion linearly movable toward and away from the support base;
a powder hopper mounted on the lifting element and adjustable in height with adjustment of the lifting element to achieve a plurality of different height filling positions for a plurality of differently sized additive manufacturing printers; and
a powder-transferring apparatus coupled with the powder hopper, the powder-transferring apparatus configured to transfer additive manufacturing powder from an additive manufacturing powder container to the powder hopper.

12. The additive manufacturing printer of claim 11, wherein the lifting element comprises a height adjustment actuator to power linear movement of the powder-filling apparatus.

13. The additive manufacturing printer of claim 11, further comprising a horizontal adjustment actuator to power horizontal movement of the powder hopper.

14. The additive manufacturing printer of claim 11, wherein the powder-filling apparatus further comprises a control system coupled with the powder-transferring apparatus, the control system controlling the powder-transferring apparatus.

15. The additive manufacturing printer of claim 11, wherein the powder hopper includes an outflow valve controlling a flow of powder from the powder hopper, and the powder-filling apparatus further comprises a control system controlling operation of the outflow valve.

16. A system comprising:
at least one computing device configured to:
determine a first fill level of an additive manufacturing powder in a feed reservoir of an additive manufacturing printer is less than a first threshold level;
open an outflow valve in a powder hopper to release additive manufacturing powder into the feed reservoir in response to determining the first fill level in the feed reservoir is less than the first threshold level;
determine a second fill level of the additive manufacturing powder in the powder hopper is less than a second threshold level; and
actuate a powder transfer apparatus coupled with the powder hopper to transfer additive manufacturing powder into the powder hopper from an additive manufacturing powder container in response to determining the second fill level in the powder hopper is less than the second threshold level.

17. The system of claim 16, wherein the at least one computing device receives a signal from a sensor system, the sensor system including at least one sensor coupled to the additive manufacturing machine, the signal identifying the first fill level.

18. The system of claim 16, further comprising the powder hopper, the powder hopper having at least one fill sensor, wherein the at least one computing device receives a signal from a sensor system, the sensor system including at least one sensor coupled with the powder hopper, the signal identifying the second fill level.

19. The system of claim 16, further comprising the powder transfer apparatus coupled with the powder hopper.

20. The system of claim 16, the at least one computing device further configured to perform at least one of:
actuating a height adjustment actuator in response to input from a user to adjust a position of the powder hopper in a first direction; or
actuating a horizontal adjustment actuator in response to input from the user to adjust a position of the powder hopper in a second direction nonparallel to the first direction.
